(19) United States
(12) Patent Application Publication
(10) Pub. No.: US 2026/0149350 A1
(43) Pub. Date: May 28, 2026

(54) DC POWER CONVERTER WITH ACTIVE POWER DISTRIBUTION

(71) Applicant: ASIAN POWER DEVICES INC., Taoyuan City (TW)

(72) Inventor: Tsung-Liang HUNG, Taoyuan City (TW)

(73) Assignee: ASIAN POWER DEVICES INC., Taoyuan City (TW)

(21) Appl. No.: 19/015,255

(22) Filed: Jan. 9, 2025

(30) Foreign Application Priority Data
Nov. 22, 2024 (TW) 113145091

(51) Int. Cl. H02M 1/00; H02J 1/08; H02J 7/34; H02M 3/158

(52) U.S. Cl. CPC H02M 1/0022; H02J 1/084; H02J 7/34; H02M 3/158

(57) ABSTRACT

A DC power converter with an active power distribution includes a power conversion unit, a plurality of switch components, and a control unit. Each switch component includes a control terminal, a first terminal, and a second terminal. The first terminals respectively receive a plurality of DC input power supplies, and the second terminals are connected to the power conversion unit. The control unit provides a plurality of control signals, and the switch components are turned on and turned off by the corresponding control signals through the control terminals so that the power conversion unit provides an output power supply. The control unit controls a proportion of the number of conductions of the switch components by the control signals according to a proportion of power provided by the DC input power supplies required by the output power supply.

### BACKGROUND

### Technical Field

The present disclosure relates to a DC power converter, and more particularly to a DC power converter with active power distribution.

### Description of Related Art

The statements in this section merely provide background information related to the present disclosure and do not necessarily constitute prior art.

Multi-input power converters often use a DC power supply acquired by converting an AC mains together with a battery power as the DC input power supply. However, existing multi-input power converters mostly use the DC power supply with fixed magnitude (i.e., converting the AC mains) and the DC input power supply (i.e., the battery power) to alternately supply power. If the magnitudes of the two power supplies are similar, there will be no power supply problems. However, if the magnitudes of the two power supplies are very different, and if the DC power supply with fixed magnitude and the DC input power supply are still used to supply power alternately, it will easily cause problems with the stability, coordination, and efficiency of power supply.

Therefore, how to design a DC power converter with active power distribution to solve the problems and technical bottlenecks in the existing technology has become a critical topic in this field.

### SUMMARY

An objective of the present disclosure is to provide a DC power converter with active power distribution. The DC power converter with active power distribution includes a power conversion unit, a plurality of switch components, and a control unit. Each switch component includes a control terminal, a first terminal, and a second terminal. The first terminals respectively receive a plurality of DC input power supplies. The second terminals are connected to the power conversion unit. The number of the switch components is the same as the number of the DC input power supplies. The control unit generates a plurality of control signals, and the control signals are provided to the control terminals of the switch components to correspondingly turn on and turn off the switch components so that the power conversion unit provides an output power supply. The control unit controls a proportion of the number of conductions of the switch components by the control signals according to a proportion of power provided by the DC input power supplies required by the output power supply.

In one embodiment, the DC power converter with active power distribution further includes a plurality of measurement units. The measurement units respectively are disposed on connection paths between the DC input power supplies and the switch components to respectively measure power provided by the DC input power supplies.

In one embodiment, the number of the DC input power supplies is two, including a first DC input power supply and a second DC input power supply; the number of the switch components is two, including a first switch component and a second switch component; the number of the control signals is two, including a first control signal and a second control signal. The control unit respectively controls the first switch component and the second switch component by the first control signal and the second control signal to alternately conduct within a period of time according to the proportion of the number of conductions.

In one embodiment, the number of the measurement units is two, including a first measurement unit and a second measurement unit. The first measurement unit measures a first power provided by the first DC input power supply, and provides a first measurement signal to the control unit. The second measurement unit measures a second power provided by the second DC input power supply, and provides a second measurement signal to the control unit.

In one embodiment, the first DC input power supply is a DC power supply converted from an AC mains. The second DC input power supply is a DC power supply provided from a battery.

In one embodiment, the power conversion unit is a buck converter for stepping down the DC input power supplies to the output power supply.

In one embodiment, the power conversion unit is a boost converter for stepping up the DC input power supplies to the output power supply.

In one embodiment, the power conversion unit is a buck-boost converter for stepping down and stepping up the DC input power supplies to the output power supply.

In one embodiment, when the output power supply of the power conversion unit needs to be provided by the first DC input power supply and the second DC input power supply in a ratio of 1:1, within a period of time, the ratio of the number of times the first switch component turned on controlled by the first control signal to the number of times the second switch component turned on controlled by the second control signal is 1:1.

In one embodiment, when the output power supply of the power conversion unit needs to be provided by the first DC input power supply and the second DC input power supply in a ratio of N:1, within a period of time, the ratio of the number of times the first switch component turned on controlled by the first control signal to the number of times the second switch component turned on controlled by the second control signal is N:1, where N is a number greater than one.

Accordingly, the DC power converter with active power distribution of the present disclosure has the following features and advantages: according to the proportion of power provided by the DC input power supplies, the proportion of the number of conductions of the switch components is controlled to generate the output power supply so that the DC input power supplies can be used flexibly and efficiently to actively distribute the DC input power supplies.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a block circuit diagram of a DC power converter with active power distribution according to a first embodiment of the present disclosure.

FIG. 2A and FIG. 2B are schematic diagrams showing a power conversion unit converting a first DC input power supply according to the DC power converter with active power distribution of the present disclosure.

FIG. 3A and FIG. 3B are schematic diagrams showing the power conversion unit converting a second DC input power supply according to the DC power converter with active power distribution of the present disclosure.

FIG. 4 is a block circuit diagram of the DC power converter with active power distribution according to a second embodiment of the present disclosure.

FIG. 5A and FIG. 5B are schematic diagrams showing a power conversion unit converting the first DC input power supply according to the DC power converter with active power distribution of the present disclosure.

FIG. 5C and FIG. 5D are schematic diagrams showing the power conversion unit converting the second DC input power supply according to the DC power converter with active power distribution of the present disclosure.

FIG. 6 is a schematic diagram showing the first DC input power supply and the second DC input power supply outputting power in a ratio of 1:1.

FIG. 7 is a schematic diagram showing the first DC input power supply and the second DC input power supply outputting power in a ratio of 2:1.

FIG. 8 is a schematic diagram showing the first DC input power supply and the second DC input power supply outputting power in a ratio of 1:2.

### DETAILED DESCRIPTION

Reference will now be made to the drawing figures to describe the present disclosure in detail. It will be understood that the drawing figures and exemplified embodiments of present disclosure are not limited to the details thereof.

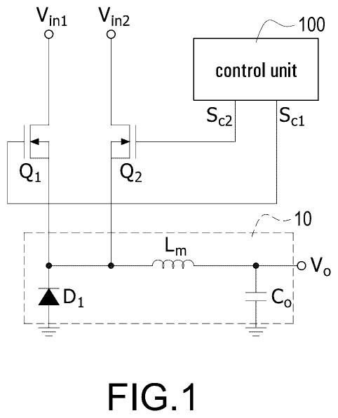

Please refer to FIG. 1, which shows a DC power converter with active power distribution according to a first embodiment of the present disclosure. The DC power converter with active power distribution (hereinafter abbreviated as “DC power converter”) includes a power conversion unit 10, a plurality of switch components Q₁, Q₂, and a control unit 100. Each switch component Q₁, Q₂ includes a control terminal, a first termina, and a second terminal. The first terminals respectively receive a plurality of DC input power supplies Vᵢₙ₁, Vᵢₙ₂, and the second terminals are connected to the power conversion unit 10. In particular, the number of the switch components Q₁, Q₂ is the same as the number of the DC input power supplies Vᵢₙ₁, Vᵢₙ₂.

The control unit 100 generates a plurality of control signals S_{C1}, S_{C2}, and the control signals S_{C1}, S_{C2} are provided to the control terminals of the switch components Q₁, Q₂ to correspondingly turn on and turn off the switch components Q₁, Q₂ so that the power conversion unit 10 provides an output power supply V_{O}.

The control unit 100 control the proportion of the number of conductions of the switch components Q₁, Q₂ by the control signals S_{C1}, S_{C2} according to the proportion of power provided by the DC input power supplies Vᵢₙ₁, Vᵢₙ₂ required by the output power supply V_{O}. As for the description of this operation, it will be detailed later.

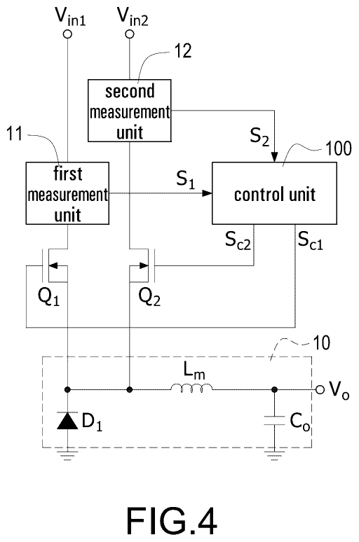

Please refer to FIG. 4, which shows a block circuit diagram of the DC power converter with active power distribution according to a second embodiment of the present disclosure. The major difference between the second embodiment shown in FIG. 4 and the first embodiment shown in FIG. 1 is that the DC power converter shown in the former further includes a plurality of measurement units 11, 12. The measurement units 11, 12 are respectively disposed on connection paths between the DC input power supplies Vᵢₙ₁, Vᵢₙ₂ and the switch components Q₁, Q₂ to respectively measure power provided by the DC input power supplies Vᵢₙ₁, Vᵢₙ₂.

For the convenience of understanding and explanation, the present disclosure will be described by taking two DC input power supplies as an example. Refer to FIG. 4 again, it is assumed that the number of the DC input power supplies Vᵢₙ₁, Vᵢₙ₂ is two, that is, a first DC input power supply Vᵢₙ₁ and a second DC input power supply Vᵢₙ₂ are included. Corresponding to the two DC input power supplies, the number of the switch components Q₁, Q₂ is two, that is, a first switch component Q₁ and a second switch component Q₂ are included. Moreover, the number of the control signals S_{C1}, S_{C2} is two, that is, a first control signal S_{C1} and a second control signal S_{C2} are included. The control unit 100 respectively controls the first switch component Q₁ and the second switch component Q₂ by the first control signal S_{C1} and the second control signal S_{C2} to alternately conduct within a period of time according to the proportion of the number of conductions. The description of this operation will be detailed later.

Correspondingly, the number of the measurement units 11, 12 is two, that is, a first measurement unit 11 and a second measurement unit 12 are included. In particular, the first measurement unit 11 measures a first power provided by the first DC input power supply Vᵢₙ₁ and provides a first measurement signal S₁ to the control unit 100. Similarly, the second measurement unit 12 measures a second power provided by the second DC input power supply Vᵢₙ₂ and provides a second measurement signal S₂ to the control unit 100.

Incidentally, in the present disclosure, the first DC input power supply Vᵢₙ₁ may be a DC power supply that is converted from an AC mains, and the second DC input power supply Vᵢₙ₂ may be a DC power supply that is provided from a battery, but is not limited to this.

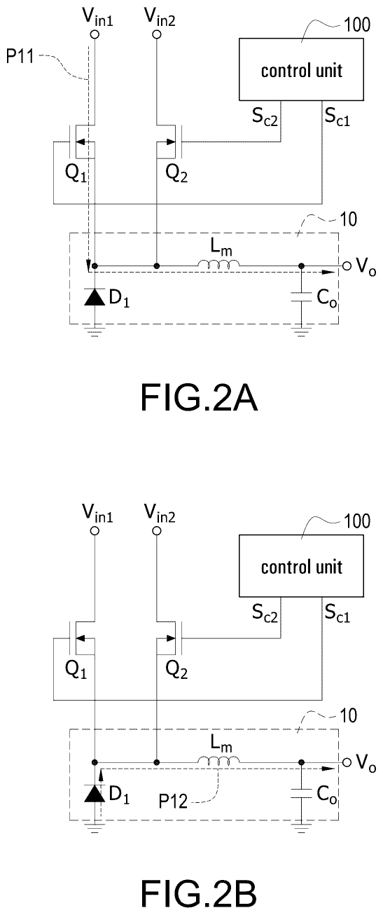

Furthermore, in the present disclosure, the power conversion unit 10 is a power conversion unit for a DC-to-DC conversion, for example, but not limited to, the power conversion unit 10 is a buck converter for stepping down the first DC input power supply Vᵢₙ₁ or stepping down the second DC input power supply Vᵢₙ₂ into the output power supply V_{O} as shown in FIG. 2. Alternatively, the power conversion unit 10 is a boost converter for stepping up the first DC input power supply Vᵢₙ₁ or stepping up the second DC input power supply Vᵢₙ₂ into the output power supply V_{O}. Alternatively, the power conversion unit 10 is a buck-boost converter for stepping down and stepping up the first DC input power supply Vᵢₙ₁ or stepping down and stepping up the second DC input power supply Vᵢₙ₂ into the output power supply V_{O}.

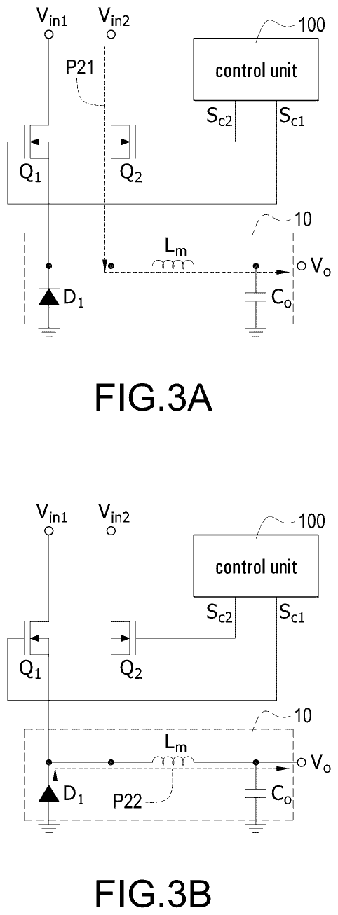

The operation of active power distribution of the DC power converter of the present disclosure will be described below, and taking FIG. 2A, FIG. 2B, FIG. 3A, and FIG. 3B as an example. When the first DC input power supply Vᵢₙ₁ supplies power, the second DC input power supply Vᵢₙ₂ does not supply power; on the conversely, when the second DC input power supply Vᵢₙ₂ supplies power, the first DC input power supply Vᵢₙ₁ does not supply power. Therefore, please refer to FIG. 2A and FIG. 2B, which are schematic diagrams showing a power conversion unit converting a first DC input power supply according to the DC power converter with active power distribution of the present disclosure.

As shown in FIG. 2A, when the first DC input power supply Vᵢₙ₁ is used to provide the output power supply V_{O} through the power conversion unit 10 (taking the buck circuit as an example), the first control signal S_{C1} provided by the control unit 100 (for example, but not limited to, the first control signal S_{C1} is a high-level signal) turns on the first switch component Q₁, and the second control signal S_{C2} provided by the control unit 100 (for example, but not limited to, the second control signal S_{C2} is a low-level signal) turns off the second switch component Q₂. Therefore, the power of the first DC input power supply Vᵢₙ₁ is stored in the inductor Lₘ of the power conversion unit 10, which is an energy storage operation, and a first energy storage path P11 is shown in FIG. 2A.

Afterward, as shown in FIG. 2B, when the first control signal S_{C1} provided by the control unit 100 (for example, but not limited to, the first control signal S_{C1} is a low-level signal) turns off the first switch component Q₁ (the second switch component Q₂ remains turned off), the energy stored in the inductor Lₘ is provided to the output side of the power conversion unit 10 through a first energy release path P12 as the output power supply V_{O}. Therefore, based on the energy storage operation in FIG. 2A and the energy release operation in FIG. 2B, the first DC input power supply Vᵢₙ₁ is completed to provide the output power supply V_{O} through the power conversion unit 10.

Similarly, please refer to FIG. 3A and FIG. 3B, which are schematic diagrams showing the power conversion unit converting a second DC input power supply according to the DC power converter with active power distribution of the present disclosure.

As shown in FIG. 3A, when the second DC input power supply Vᵢₙ₂ is used to provide the output power supply V_{O} through the power conversion unit 10 (taking the buck circuit as an example), the second control signal S_{C2} provided by the control unit 100 (for example, but not limited to, the second control signal S_{C2} is a high-level signal) turns on the second switch component Q₂, and the first control signal S_{C1} provided by the control unit 100 (for example, but not limited to, the first control signal S_{C1} is a low-level signal) turns off the first switch component Q₁. Therefore, the power of the second DC input power supply Vᵢₙ₂ is stored in the inductor Lₘ of the power conversion unit 10, which is an energy storage operation, and a second energy storage path P21 is shown in FIG. 3A.

Afterward, as shown in FIG. 3B, when the second control signal S_{C2} provided by the control unit 100 (for example, but not limited to, the second control signal S_{C2} is a low-level signal) turns off the second switch component Q₂ (the first switch component Q₁ remains turned off), the energy stored in the inductor Lₘ is provided to the output side of the power conversion unit 10 through a second energy release path P22 as the output power supply V_{O}. Therefore, based on the energy storage operation in FIG. 3A and the energy release operation in FIG. 3B, the second DC input power supply Vᵢₙ₂ is completed to provide the output power supply V_{O} through the power conversion unit 10.

Therefore, when the output power supply V_{O} of the power conversion unit 10 needs to be provided by the first DC input power supply Vᵢₙ₁ and the second DC input power supply Vᵢₙ₂ in a ratio of 1:1, within a period of time, the ratio of the number of times the first switch component Q₁ turned on controlled by the first control signal S_{C1} to the number of times the second switch component Q₂ turned on controlled by the second control signal S_{C2} is 1:1, for example, both are 100 times. In other words, the first DC input power supply Vᵢₙ₁ and the second DC input power supply Vᵢₙ₂ take turns to provide the output power supply V_{O} of the power conversion unit 10 in an interleaving (or alternating) manner.

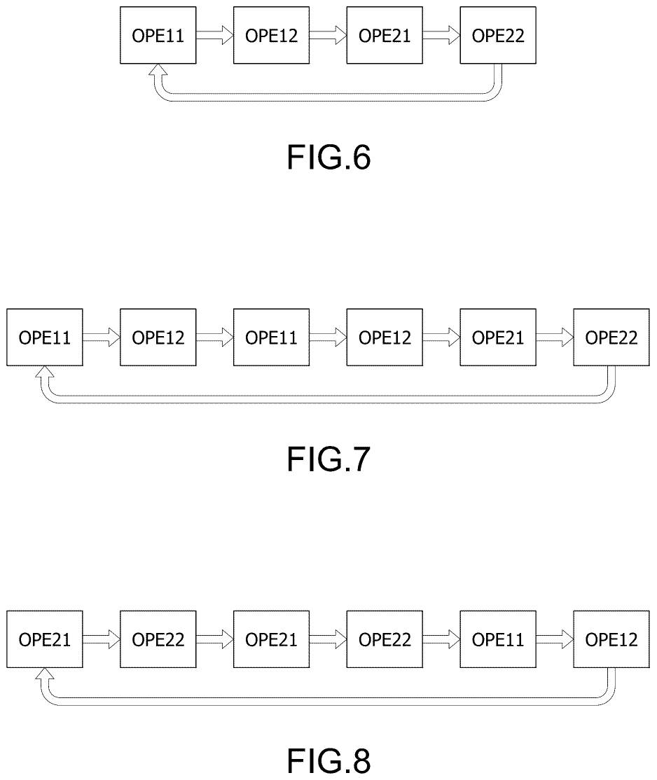

Please refer to FIG. 6, which shows a schematic diagram showing the first DC input power supply and the second DC input power supply outputting power in a ratio of 1:1. As shown in FIG. 6, OPE11 illustrates that the inductor Lₘ of the power conversion unit 10 operates in a first energy storage of FIG. 2A, OPE12 illustrates that the inductor Lₘ of the power conversion unit 10 operates in a first energy release of FIG. 2B, OPE21 illustrates that the inductor Lₘ of the power conversion unit 10 operates in a second energy storage of FIG. 3A, and OPE22 illustrates that the inductor Lₘ of the power conversion unit 10 operates in a second energy release of FIG. 3B. FIG. 6 shows the continuous operations of the first energy storage, the first energy release, the second energy storage, and the second energy release (that is, after the second energy release is completed, the first energy storage is continued), and therefore the output power supply V_{O} of the power conversion unit 10 requires the power provided by the first DC input power supply Vᵢₙ₁ and the second DC input power supply Vᵢₙ₂ is 1:1.

The present disclosure can not only realize the power supply operation when the output power supply V_{O} needs to be provided by the first DC input power supply Vᵢₙ₁ and the second DC input power supply Vᵢₙ₂ in a ratio of 1:1, but can also further realize the power supply operation when the output power supply V_{O} needs to be provided by the first DC input power supply Vᵢₙ₁ and the second DC input power supply Vᵢₙ₂ in a ratio of N:1, where N is a number greater than one, as explained below.

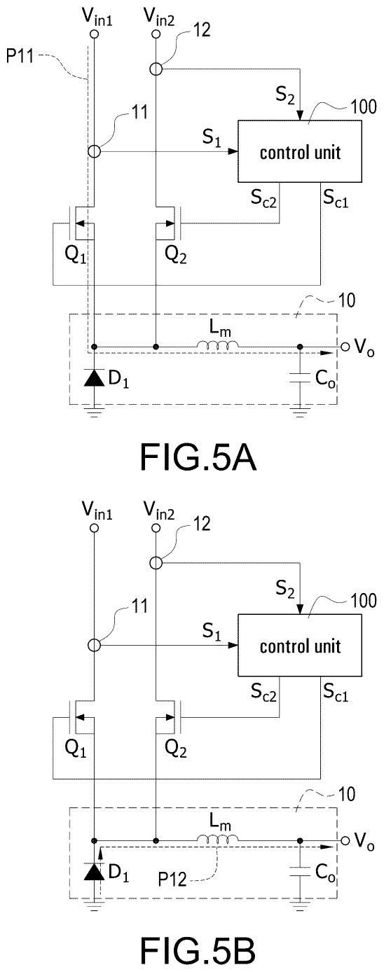

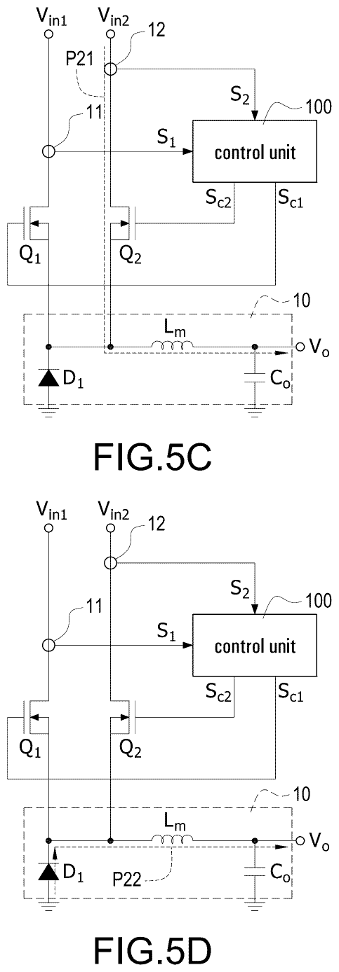

Please refer to FIG. 5A and FIG. 5B, which show schematic diagrams showing a power conversion unit converting the first DC input power supply according to the DC power converter with active power distribution of the present disclosure, and also refer to FIG. 4.

As mentioned above, compared with FIG. 1, FIG. 4 further includes the first measurement unit 11 and the second measurement unit 12. The first measurement unit 11 measures the first power provided by the first DC input power supply Vᵢₙ₁ and provides the first measurement signal S₁ to the control unit 100. Similarly, the second measurement unit 12 measures the second power provided by the second DC input power supply Vᵢₙ₂ and provides the second measurement signal S₂ to the control unit 100. Therefore, the control unit 100 control the proportion of the number of conductions of the switch components Q₁, Q₂ by the control signals S_{C1}, S_{C2} according to the proportion of power provided by the DC input power supplies Vᵢₙ₁, Vᵢₙ₂ required by the output power supply V_{O}.

As shown in FIG. 5A, when the first DC input power supply Vᵢₙ₁ is used to provide the output power supply V_{O} through the power conversion unit 10 (taking the buck circuit as an example), the first control signal S_{C1} provided by the control unit 100 (for example, but not limited to, the first control signal S_{C1} is a high-level signal) turns on the first switch component Q₁, and the second control signal S_{C2} provided by the control unit 100 (for example, but not limited to, the second control signal S_{C2} is a low-level signal) turns off the second switch component Q₂. Therefore, the power of the first DC input power supply Vᵢₙ₁ is stored in the inductor Lₘ of the power conversion unit 10, which is an energy storage operation, and a first energy storage path P11 is shown in FIG. 5A. Furthermore, the first power flowing from the first DC input power supply Vᵢₙ₁ through the first switch component Q₁ can be measured by the first measurement unit 11.

Afterward, as shown in FIG. 5B, when the first control signal S_{C1} provided by the control unit 100 (for example, but not limited to, the first control signal S_{C1} is a low-level signal) turns off the first switch component Q₁ (the second switch component Q₂ remains turned off), the energy stored in the inductor Lₘ is provided to the output side of the power conversion unit 10 through a first energy release path P12 as the output power supply V_{O}. Therefore, based on the energy storage operation in FIG. 5A and the energy release operation in FIG. 5B, the first DC input power supply Vᵢₙ₁ is completed to provide the output power supply V_{O} through the power conversion unit 10.

Similarly, please refer to FIG. 5C and FIG. 5D, which show schematic diagrams showing the power conversion unit converting the second DC input power supply according to the DC power converter with active power distribution of the present disclosure.

As shown in FIG. 5C, when the second DC input power supply Vᵢₙ₂ is used to provide the output power supply V_{O} through the power conversion unit 10 (taking the buck circuit as an example), the second control signal S_{C2} provided by the control unit 100 (for example, but not limited to, the second control signal S_{C2} is a high-level signal) turns on the second switch component Q₂, and the first control signal S_{C1} provided by the control unit 100 (for example, but not limited to, the first control signal S_{C1} is a low-level signal) turns off the first switch component Q₁. Therefore, the power of the second DC input power supply Vᵢₙ₂ is stored in the inductor Lₘ of the power conversion unit 10, which is an energy storage operation, and a second energy storage path P21 is shown in FIG. 5C. Furthermore, the second power flowing from the second DC input power supply Vᵢₙ₂ through the second switch component Q₂ can be measured by the second measurement unit 12.

Afterward, as shown in FIG. 5D, when the second control signal S_{C2} provided by the control unit 100 (for example, but not limited to, the second control signal S_{C2} is a low-level signal) turns off the second switch component Q₂ (the first switch component Q₁ remains turned off), the energy stored in the inductor Lₘ is provided to the output side of the power conversion unit 10 through a second energy release path P22 as the output power supply V_{O}. Therefore, based on the energy storage operation in FIG. 5C and the energy release operation in FIG. 5D, the second DC input power supply Vᵢₙ₂ is completed to provide the output power supply V_{O} through the power conversion unit 10.

Therefore, according to the magnitudes of the first power and the second power measured respectively by the first measurement unit 11 and the second measurement unit 12, when the output power supply V_{O} of the power conversion unit 10 needs to be provided by the first DC input power supply Vᵢₙ₁ and the second DC input power supply Vᵢₙ₂ in a ratio of N:1 (that is, the determination is based on the available first power and the second power), within a period of time, the ratio of the number of times the first switch component Q₁ turned on controlled by the first control signal S_{C1} to the number of times the second switch component Q₂ turned on controlled by the second control signal S_{C2} is N:1, for example, the number of times the first switch component Q₁ turned on is 100 times, and the number of times the second switch component Q₂ turned on is 50 times, i.e., N is 2. Alternatively, for example, the number of times the first switch component Q₁ turned on is 50 times, and the number of times the second switch component Q₂ turned on is 100 times, i.e., N is 0.5. In other words, the first DC input power supply Vᵢₙ₁ and the second DC input power supply Vᵢₙ₂ take turns to provide the output power supply V_{O} of the power conversion unit 10 in an interleaving (or alternating) manner.

For example, if the ratio of the available power of the first DC input power supply Vᵢₙ₁ to the available power of the second DC input power supply Vᵢₙ₂ is about 2:1, it is possible to control the first DC input power supply Vᵢₙ₁ to provide more power as output power V_{O}. Therefore, the ratio of the number of conductions of the first switch component Q₁ to the number of conductions of the second switch component Q₂ may be controlled to 2:1, which allows the first DC input power supply Vᵢₙ₁ to bear a higher power supply responsibility.

Please refer to FIG. 7, which shows a schematic diagram showing the first DC input power supply and the second DC input power supply outputting power in a ratio of 2:1. As shown in FIG. 7, OPE11 illustrates that the inductor Lₘ of the power conversion unit 10 operates in a first energy storage of FIG. 5A, OPE12 illustrates that the inductor Lₘ of the power conversion unit 10 operates in a first energy release of FIG. 5B, OPE21 illustrates that the inductor Lₘ of the power conversion unit 10 operates in a second energy storage of FIG. 5C, and OPE22 illustrates that the inductor Lₘ of the power conversion unit 10 operates in a second energy release of FIG. 5D. FIG. 7 shows the continuous operations of the first energy storage, the first energy release, the first energy storage, the first energy release (that is, the first energy storage and the first energy release are operated twice continuously), the second energy storage, and the second energy release (that is, after the second energy release is completed, the first energy storage is continued), and therefore the output power supply V_{O} of the power conversion unit 10 requires the power provided by the first DC input power supply Vᵢₙ₁ and the second DC input power supply Vᵢₙ₂ is 2:1.

However, although the energy storage and energy release operations of FIG. 7 can achieve that the power provided by the first DC input power supply Vᵢₙ₁ and the second DC input power supply Vᵢₙ₂ is 2:1, but is not limited to this. In other words, as long as the first energy storage and the first energy release can be performed twice within a period of time (not necessarily twice consecutively as shown in FIG. 7), and the second energy storage and the second energy release can be performed once, the power provided by the first DC input power supply Vᵢₙ₁ and the second DC input power supply Vᵢₙ₂ being 2:1 can be achieved. Similarly, if it is to achieve the power provided by the first DC input power supply Vᵢₙ₁ and the second DC input power supply Vᵢₙ₂ being 3:1, as long as the first energy storage and the first energy release can be performed three times within a period of time (not necessarily three times consecutively), and the second energy storage and the second energy release can be performed once, the power provided by the first DC input power supply Vᵢₙ₁ and the second DC input power supply Vᵢₙ₂ being 3:1 can be achieved, and so on.

On the contrary, if the ratio of the available power of the first DC input power supply Vᵢₙ₁ to the available power of the second DC input power supply Vᵢₙ₂ is about 1:2, it is possible to control the second DC input power supply Vᵢₙ₂ to provide more power as output power V_{O}. Therefore, the ratio of the number of conductions of the first switch component Q₁ to the number of conductions of the second switch component Q₂ may be controlled to 1:2, which allows the second DC input power supply Vᵢₙ₂ to bear a higher power supply responsibility.

Please refer to FIG. 8, which shows a schematic diagram showing the first DC input power supply and the second DC input power supply outputting power in a ratio of 1:2. As shown in FIG. 8, OPE11 illustrates that the inductor Lₘ of the power conversion unit 10 operates in a first energy storage of FIG. 5A, OPE12 illustrates that the inductor Lₘ of the power conversion unit 10 operates in a first energy release of FIG. 5B, OPE21 illustrates that the inductor Lₘ of the power conversion unit 10 operates in a second energy storage of FIG. 5C, and OPE22 illustrates that the inductor Lₘ of the power conversion unit 10 operates in a second energy release of FIG. 5D. FIG. 8 shows the continuous operations of the second energy storage, the second energy release, the second energy storage, the second energy release (that is, the second energy storage and the second energy release are operated twice continuously), the first energy storage, and the first energy release (that is, after the first energy release is completed, the second energy storage is continued), and therefore the output power supply V_{O} of the power conversion unit 10 requires the power provided by the first DC input power supply Vᵢₙ₁ and the second DC input power supply Vᵢₙ₂ is 1:2.

However, although the energy storage and energy release operations of FIG. 8 can achieve that the power provided by the first DC input power supply Vᵢₙ₁ and the second DC input power supply Vᵢₙ₂ is 1:2, but is not limited to this. In other words, as long as the second energy storage and the second energy release can be performed twice within a period of time (not necessarily twice consecutively as shown in FIG. 8), and the first energy storage and the first energy release can be performed once, the power provided by the first DC input power supply Vᵢₙ₁ and the second DC input power supply Vᵢₙ₂ being 1:2 can be achieved. Similarly, if it is to achieve the power provided by the first DC input power supply Vᵢₙ₁ and the second DC input power supply Vᵢₙ₂ being 1:3, as long as the second energy storage and the second energy release can be performed three times within a period of time (not necessarily three times consecutively), and the first energy storage and the first energy release can be performed once, the power provided by the first DC input power supply Vᵢₙ₁ and the second DC input power supply Vᵢₙ₂ being 1:3 can be achieved, and so on.

Therefore, the present disclosure has the following features and advantages: according to the proportion of power provided by the DC input power supplies Vᵢₙ₁, Vᵢₙ₂, the proportion of the number of conductions of the switch components Q₁, Q₂ is controlled to generate the output power supply V_{O} so that the DC input power supplies Vᵢₙ₁, Vᵢₙ₂ can be used flexibly and efficiently to actively distribute the DC input power supplies Vᵢₙ₁, Vᵢₙ₂.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A DC power converter with active power distribution, comprising:
a power conversion unit,
a plurality of switch components, each switch component comprising a control terminal, a first terminal, and a second terminal; the first terminals configured to respectively receive a plurality of DC input power supplies, and the second terminals connected to the power conversion unit; wherein the number of the switch components is the same as the number of the DC input power supplies, and
a control unit configured to generate a plurality of control signals, and the control signals provided to the control terminals of the switch components to correspondingly turn on and turn off the switch components so that the power conversion unit configured to provide an output power supply,
wherein the control unit is configured to control a proportion of the number of conductions of the switch components by the control signals according to a proportion of power provided by the DC input power supplies required by the output power supply.

2. The DC power converter with active power distribution as claimed in claim 1, further comprising:
a plurality of measurement units respectively disposed on connection paths between the DC input power supplies and the switch components to respectively measure power provided by the DC input power supplies.

3. The DC power converter with active power distribution as claimed in claim 2, wherein the number of the DC input power supplies is two, comprising a first DC input power supply and a second DC input power supply; the number of the switch components is two, comprising a first switch component and a second switch component; the number of the control signals is two, comprising a first control signal and a second control signal,
wherein the control unit is configured to respectively control the first switch component and the second switch component by the first control signal and the second control signal to alternately conduct within a period of time according to the proportion of the number of conductions.

4. The DC power converter with active power distribution as claimed in claim 3, wherein the number of the measurement units is two, comprising a first measurement unit and a second measurement unit,
wherein the first measurement unit is configured to measure a first power provided by the first DC input power supply, and provide a first measurement signal to the control unit; the second measurement unit is configured to measure a second power provided by the second DC input power supply, and provide a second measurement signal to the control unit.

5. The DC power converter with active power distribution as claimed in claim 3, wherein the first DC input power supply is a DC power supply converted from an AC mains; the second DC input power supply is a DC power supply provided from a battery.

6. The DC power converter with active power distribution as claimed in claim 1, wherein the power conversion unit is a buck converter for stepping down the DC input power supplies to the output power supply.

7. The DC power converter with active power distribution as claimed in claim 1, wherein the power conversion unit is a boost converter for stepping up the DC input power supplies to the output power supply.

8. The DC power converter with active power distribution as claimed in claim 1, wherein the power conversion unit is a buck-boost converter for stepping down and stepping up the DC input power supplies to the output power supply.

9. The DC power converter with active power distribution as claimed in claim 3, wherein when the output power supply of the power conversion unit needs to be provided by the first DC input power supply and the second DC input power supply in a ratio of 1:1, within a period of time, the ratio of the number of times the first switch component turned on controlled by the first control signal to the number of times the second switch component turned on controlled by the second control signal is 1:1.

10. The DC power converter with active power distribution as claimed in claim 3, wherein when the output power supply of the power conversion unit needs to be provided by the first DC input power supply and the second DC input power supply in a ratio of N:1, within a period of time, the ratio of the number of times the first switch component turned on controlled by the first control signal to the number of times the second switch component turned on controlled by the second control signal is N:1, where N is a number greater than one.
